(19) United States
(12) Patent Application Publication
(10) Pub. No.: US 2019/0318314 A1
(43) Pub. Date: Oct. 17, 2019

(54) System and Method of Storing and Managing Digital Business Cards on a Portable computing device

(71) Applicant: Jessica L HATCHER, Alexandria, VA (US)

(72) Inventor: Jessica L HATCHER, Alexandria, VA (US)

(21) Appl. No.: 15/953,910

(22) Filed: Apr. 16, 2018

(51) Int. Cl. G06Q 10/10; H04W 4/80

(52) U.S. Cl. CPC G06Q 10/109; H04W 4/80

(57) ABSTRACT

A system and method of managing digital business cards, the method includes the steps of providing a plurality of digital business cards stored on a portable computing device. The method includes the steps of prompting to create a new card with the portable computing device; executing a card design process for the new card with the portable computing device, if the portable computing device receives a confirmation to create the new card; appending the new card into the plurality of digital business cards with the portable computing device; prompting to select at least one shared card from the plurality of digital business cards with the portable computing device; prompting to identify a desired contact information with the portable computing device; and sending the shared card from the portable computing device to the desired contact information, if the portable computing device receives a selection for the shared card, and if the portable computing device receives an identification for the desired contact information;

### FIELD OF THE INVENTION

The present invention generally relates to system and method of storing and managing digital business cards on a portable computing device such as a smartphone. More specifically, the method utilizes the portable computing device to design and distribute customized digital business cards among business contacts.

### BACKGROUND OF THE INVENTION

Well-designed business cards can help businesses attract customers and differentiate themselves from competitors with eye catching designs and logos. However, designing and printing business cards can present a considerable expense for small businesses. Many small businesses may find having to constantly update and print new business cards unaffordable. Further, business owners may find having to carry and keep track of different types of digital business cards burdensome. Physical business cards, although laminated, can also get damaged or lost, and need to be constantly replaced. As such, the present invention is a method and system of creating, storing, and exchanging digital business cards on a portable computing device such as a smartphone. This solves the problem of having to constantly update, print, and replace physical business cards.

The present invention is a method and system of managing digital business cards. The present invention facilitates the creation and exchange of digital business cards through a portable computing device such as a smartphone or a tablet computer. A user can create or upload a customized business card into the portable computing device and share the digital business card through a plurality of third-party communication applications. For example, the digital business card may be exchanged via an email, a text message, or shared on a social network profile. Further, the near-file communication (NFC) is utilized to enable a user to exchange the digital business card by simply touching the portable computing device with another computing device.

The user can add filters and photographic effects to visually enhance the digital business card. The digital business card may also have an embedded video or GIF showcasing the business of the individual that owns the digital business card. Various design tools are available for the user to create a digital business card that is customized for specific businesses and individuals. For example, a cosmetology business card may have a video or GIF of a pretty girl with long hair with changing colors. A business card for a lawn company may have a lawnmower driving across the card and cutting grass. Further, the video or GIF can also be embedded into a static image. For example, a static image may be coupled with a motion frame displaying a moving image. The trim of the card could be falling rain or snow or flashing neon lights.

### BRIEF DESCRIPTION OF THE DRAWINGS

FIG. 1 is a schematic view of the present invention showing the digital business card being exchanged between the portable computing device and the other computing device.

FIG. 2 is a flowchart showing Step A through Step G.

FIG. 3 is flowchart of a subprocess of Step C, wherein the new card is chosen from a plurality of graphics files.

FIG. 4 is flowchart of a subprocess of Step C, wherein the desired file is a static image.

FIG. 5 is flowchart of a subprocess of Step C, wherein the desired file is a dynamic image.

FIG. 6 is flowchart of a subprocess of Step C, wherein the design process allows for the creation of a fully customized digital business card.

FIG. 7 is flowchart of a subprocess of Step F, wherein the desired contact information is chosen from a plurality of third-party communication applications.

FIG. 8 is a flowchart of a subprocess of Step F, wherein the desired contact information is a phone number.

FIG. 9 is a flowchart of a subprocess of Step F, wherein the desired contact information is a unique identifier on a personal area network.

FIG. 10 is a flowchart of a subprocess of Step F, wherein the desired contact information is the close proximity of the other computing device.

FIG. 11 is a flowchart of a subprocess of Step F, wherein the shared card is sent to the other computing device through the NFC connection.

FIG. 12 is a flowchart of a subprocess of Step F, wherein the desired contact information is chosen from a plurality of contact profiles.

FIG. 13 is a flowchart of a subprocess of Step F, wherein a new contact profile is appended to the plurality of contact profiles.

### DETAILED DESCRIPTION OF THE INVENTION

All illustrations of the drawings are for the purpose of describing selected versions of the present invention and are not intended to limit the scope of the present invention.

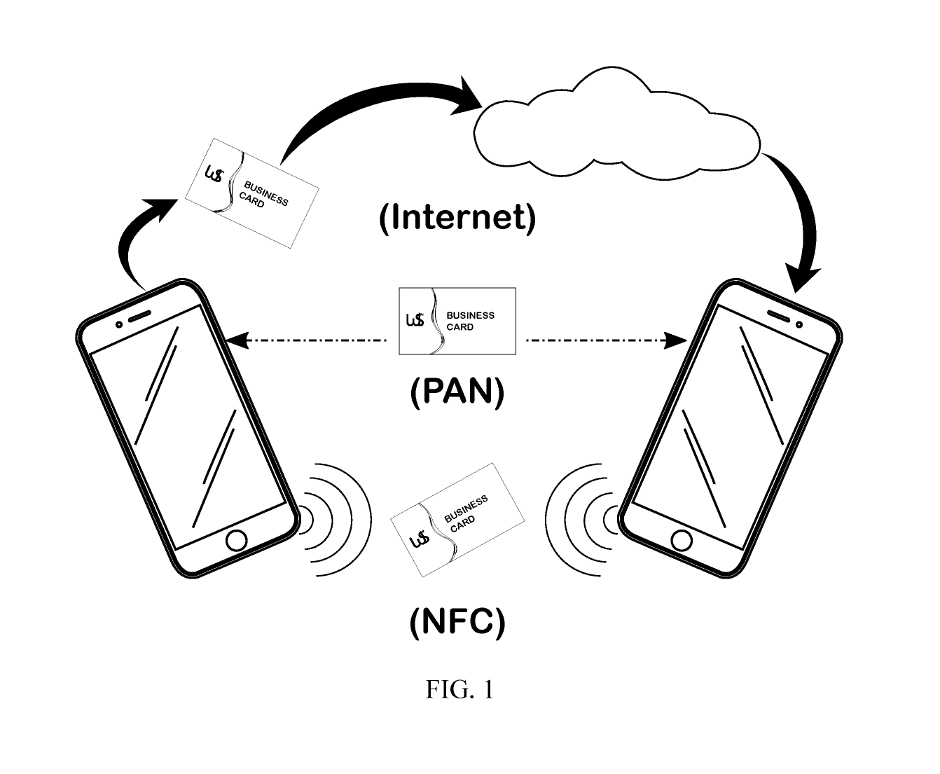

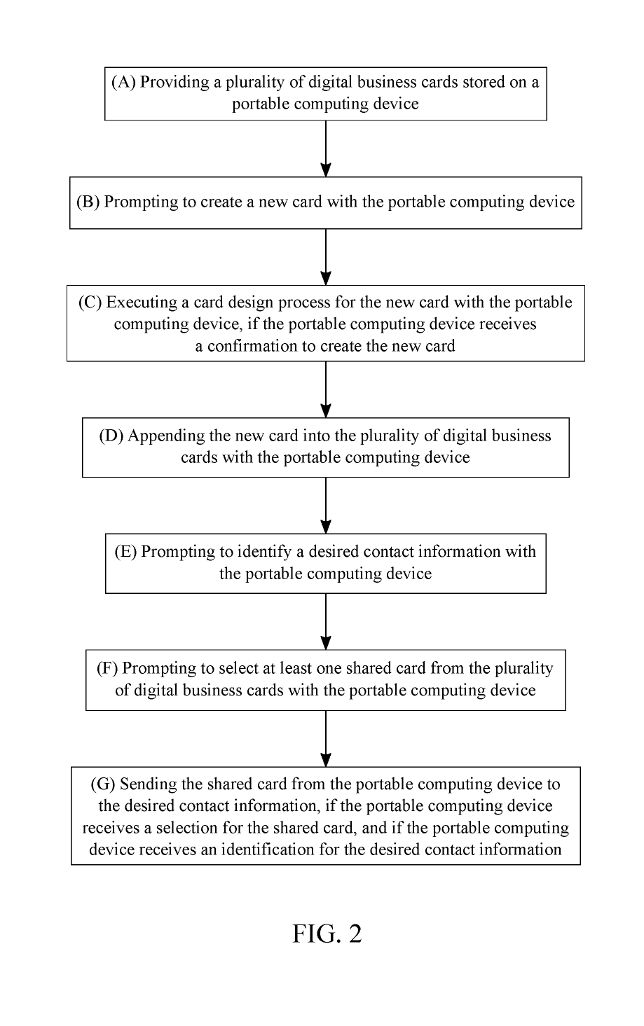

Referring to FIG. 1 and FIG. 2, the present invention is a method of managing digital business cards. The method allows users to create customized business cards, send the customized business cards to business contacts, and to save business cards sent by business contacts. The method comprises the steps of providing a plurality of digital business cards stored on a portable computing device (A). As such, the portable computing device comprises a non-transitory computer-readable storage medium for storing the method and a processor for executing the method. More specifically, the method is stored as an application in a storage medium. Preferably, the portable computing device is a handheld client computer such as a smartphone or a tablet running on a mobile operating system(OS). In the preferred implementation, the plurality of digital business cards is created and stored completely on the portable computing device. Thus, the portable computing device prompts the user to create a new card (B). In alternate embodiments of the present invention, the portable computing device may be connected to a remote server that performs a portion of the editing, storing, and distributing processes of the application.

Referring more specifically to FIG. 2, if the portable computing device receives a confirmation to create the new card, the portable computing device executes a card design process (C). The design process allows the user to create and customize the new card by adding images, texts, and graphical elements that are stored in the portable computing device. The user can thus design the card to suit specific businesses or occasions. For example, the user may incorporate a photo stored in the portable computing device into the new card. Once the new card is created, the portable computing device appends the new card into the plurality of digital business cards (D). As such, each of the plurality of digital business cards can be customized for a specific business or a special occasion. Once the plurality of digital cards is created, the user can exchange one or more cards with business contacts. More specifically, the portable computing device prompts to select at least one shared card from the plurality of digital business cards (E). The shared card refers to a card from the plurality of digital business cards that is sent to the business contact. Preferably, the shared card can be sent via a text message, an email, or a short-range radio wave connection. The portable computing device then prompts to identify a desired contact information (F). Depending on the method of communication, the desired contact information may include a phone number, an email address, an IP address, or a media access control (MAC) address. If the portable computing device receives a selection for the shared card, and if the portable computing device receives an identification for the desired contact information, the shared card is sent to the desired contact information from the portable computing device (G).

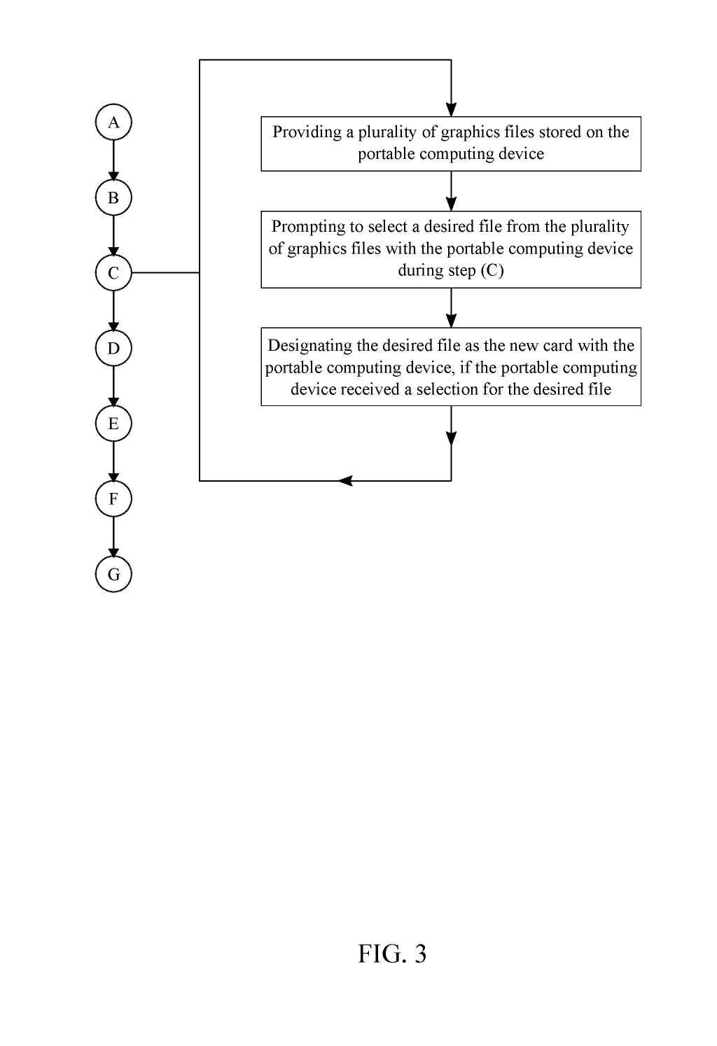

Referring to FIG. 3, the design process allows the user to append an existing digital business card to the plurality of digital business cards. As such, the portable computing device provides a plurality of graphics files stored on the portable computing device. The plurality of graphical files is preferably a digital business card created by a third-party application and stored in the portable computing device. The plurality of graphical files is preferably stored in the hard drive or the solid-state drive (SSD) of the portable computing device. The portable computing device then prompts to select a desired file from the plurality of graphics files during step (C). More specifically, the application accesses the hard drive or the SSD and presents the desired file to the user. Thus, if the portable computing device receives a selection of the desired file, the portable computing device designates the desired file as the new card. The new card is then appended to the plurality of digital business cards.

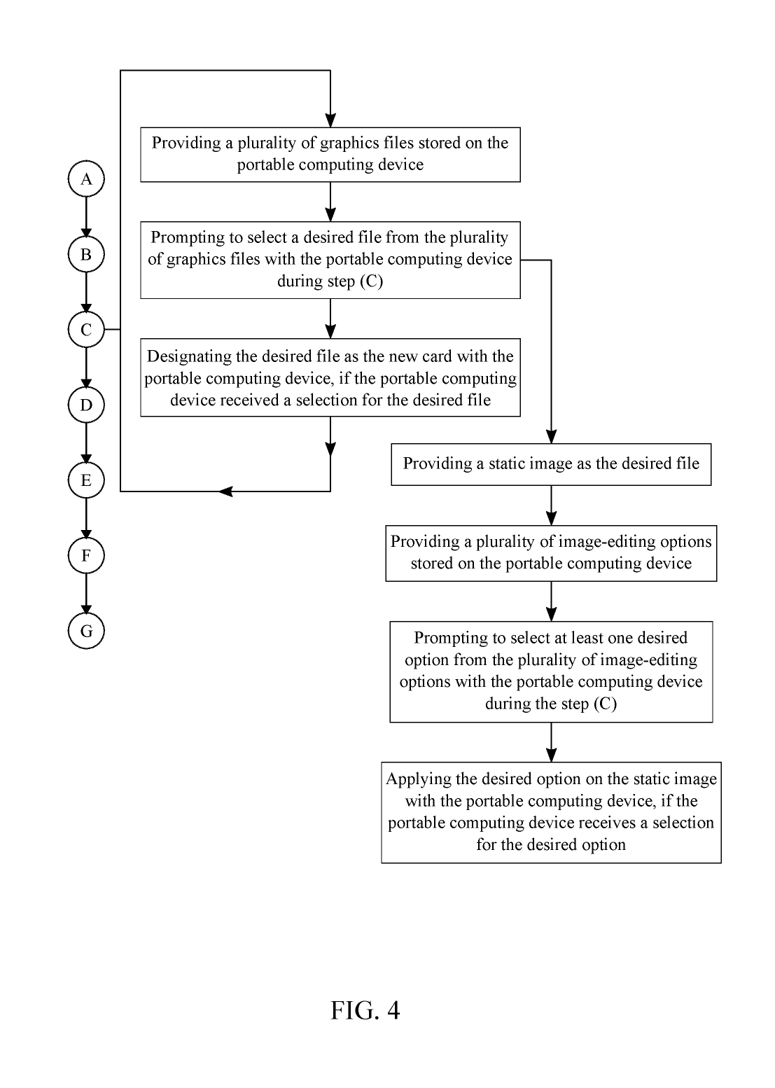

Referring to FIG. 4, in one possible embodiment of the present invention, a static image is provided as the desired file. The static image may be a photo of a physical business card or an image file created by a third-party graphical editing application such as Photoshop. For example, the user may take a photo of a physical business card and store it on the portable computing device. Similarly, the user may create a digital business card using Photoshop and download the digital business card into the portable computing device. In this case, Photoshop may format the digital business card into a common file format. More specifically, the static file may be formatted as a JPEG, PNG, TIFF, GIF, BMP, or a Vector format such as CGM, SVG, and the like. Before appending the static image into the plurality of digital business cards, the user can perform minor edits on the static image. As such, the user is provided with a plurality of image-editing options stored on the portable computing device. The plurality of image-editing options allows the user to perform minor edits on the static image. In the preferred embodiment of the present invention, the plurality of image-editing options comprises a cropping option and a rotating option. The cropping option cuts the edges of the static image whereas the rotating option rotates the static image in relation to the screen of the portable computing device. As such, the user is prompted to select at least one desired option from the plurality of image-editing options with the portable computing device during step (C). If the portable computing device receives a selection for the desired option, the portable computing device applies the desired option on the static image. Preferably, all of the edits made to the static image are saved. However, the user may be given the option to revert the static image to the unaltered state.

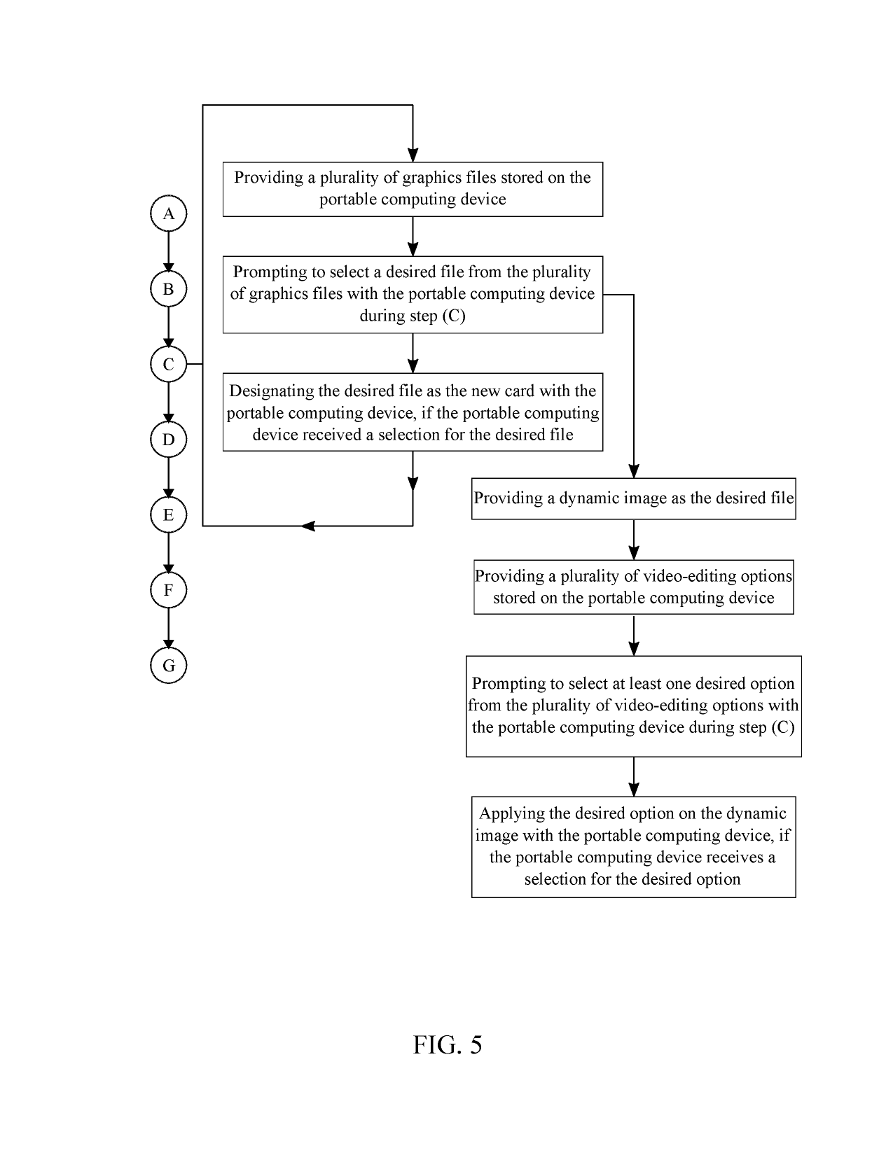

Referring to FIG. 5, in another possible embodiment of the present invention, a dynamic image is provided as the desired file. The dynamic image refers to a digital business card with moving images and animations. For example, the dynamic image may be a video-embedded business card. Preferably, the dynamic image is formatted as a high-quality GIF file. For example, the dynamic image may be a high pixel count GIF file with static text fields and a dynamic background. Alternately, the dynamic image may be a video file embedded into a static image file. Preferably, the application automatically embeds the video into the desired contact information, thus obviating the need to have a separate application to open and run the video. For example, if the desired contact information is a phone number, the application may embed the video into the text message. Likewise, if the desired contact information is an email address, the application may embed the video into the email. Before sending the dynamic image, the user can perform minor edits to the dynamic image. As such, the user is provided with a plurality of video-editing options stored in the portable computing device. Further, the user is prompted to select at least one desired option from the plurality of video-editing options with the portable computing device during the Step (C). The plurality of video-editing options may allow the user to crop, tilt, or rotate the dynamic image. If the portable computing device receives a selection for the desired option, the portable computing device applies the desired option on the dynamic image. Preferably, all of the changes made to the desired image are saved. However, the user may be given the option to revert the desired image to the unaltered state.

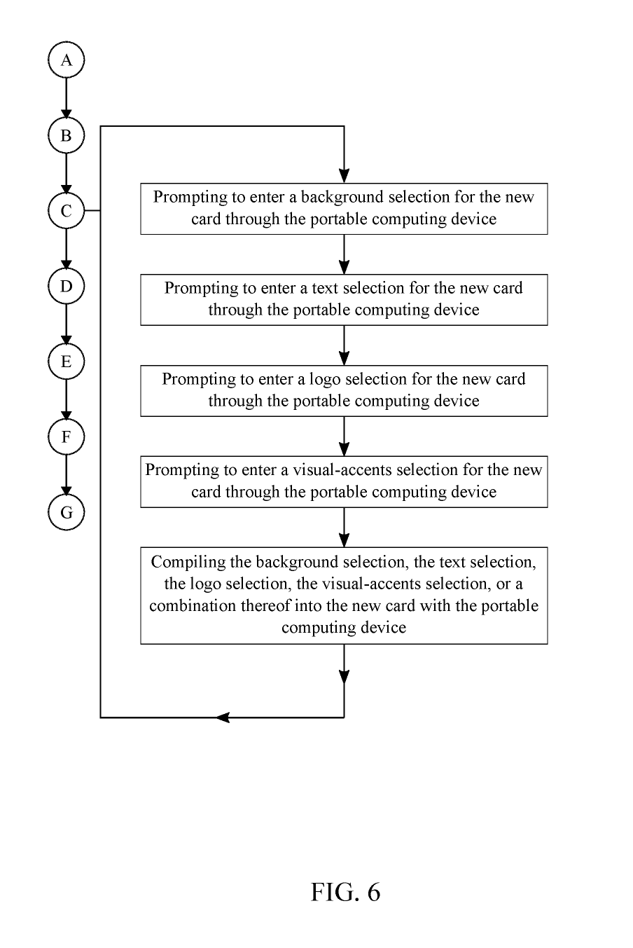

Referring to FIG. 6, the design process also allows the user to completely customize the new card by adding unique backgrounds, texts, logos, and visual accents. As such, the user is prompted to enter a background selection for the new card through the portable computing device. The background may be an image file stored in the portable computing device. The image file is preferably created by a third-party application or uploaded by the user. Once the background is chosen, the user is prompted to enter a text selection for the new card through the portable computing device. The text selection may be a company name, a personal name, contact information, and a short description. The application also comprises a word processor that stores, manipulates, and formats the text selection. Using the word processor, the user can choose the fonts, adjust the margins, and the set the rulers of the text selection. The text selections may be arranged in a manner which draws the eye to a focal point on the new card. The focal point can be used to place a logo or a company or a photo of an individual. To upload a logo, the user is prompted to enter a logo selection for the new card through the portable computing device. Like the background, the logo may be a simple image file stored in the portable computing device. Choosing the logo selection may pull up all the image files stored in the portable computing device, whereby the user must choose the appropriate file.

To further distinguish the new card, the user can also add visual-accents to the new card. As such, the user is prompted to enter a visual-accent selection for the new card through the portable computing device. Visual-accent selection allows the user to apply image filters and photo effects to the new card. As such, the visual-accent selection can be used to adjust exposure, contrast, colors, color temperature, color balance, and other image qualities of the new card. In the preferred embodiment, the user can publish the new card any time during the design process without having to go through all of the aforementioned steps. As such, the portable computer device compiles the background selection, the text selection, the logo selection, the visual-accents selection, or a combination thereof into the new card. Once the new card is published, the new card is appended to the plurality of digital business cards.

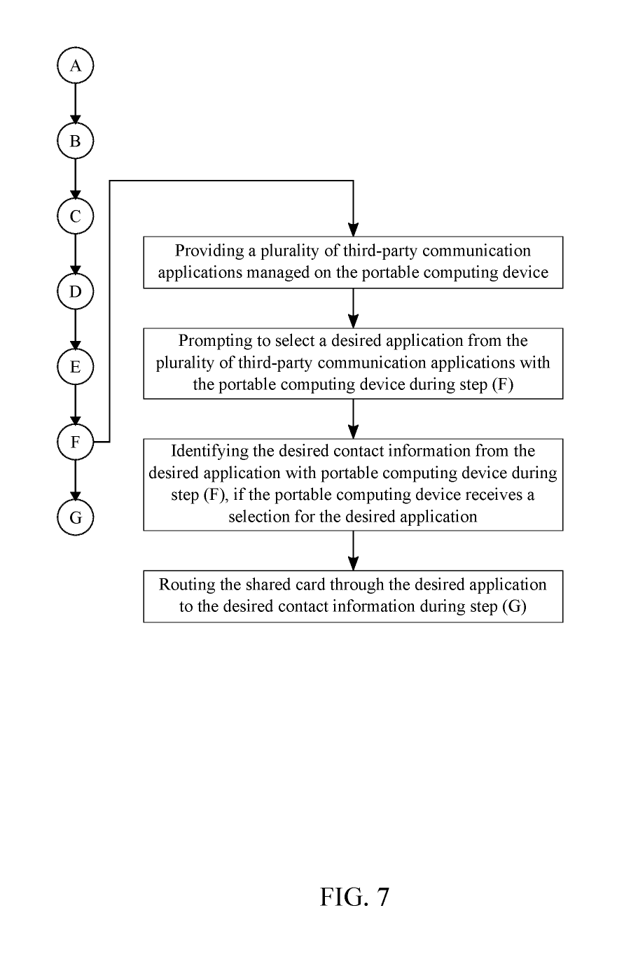

Referring to FIG. 7, focusing on Step F of the present invention, to exchange the shared card with business contacts, the application uses an already existing third-party application stored in the portable computing device. As such, the user is provided with a plurality of third-party communication applications managed on the portable computing device. Third-party communication applications may refer to default messaging applications, social networking applications, email applications, or the like, pre-installed or downloaded onto the portable computing device. The user is then prompted to select a desired application from the plurality of third-party communication applications with the portable computing device during Step F. The user may choose at least one desired application from the plurality of third-party communication applications or the user may choose more than one desired applications. The application embeds the shared card into the desired application, thereby allowing the business contact to view the shared card on the desired application. If the portable computing device receives a selection for the desired application, the user identifies the desired contact information from the desired application with portable computing device during Step F. Depending on the desired application, the desired contact information may be a phone-number, an email address, a name of the business contact, a profile in a social networking site, or any other identifying information. The application then routs the shared card through the desired application to the desired contact information during Step G. The shared card is preferably formatted into a file that can be embedded into the desired application. As such, the business contact receiving the shared card may view the shared card with either the static image or dynamic image, without having to exit or download the shared card from the third-party communication application.

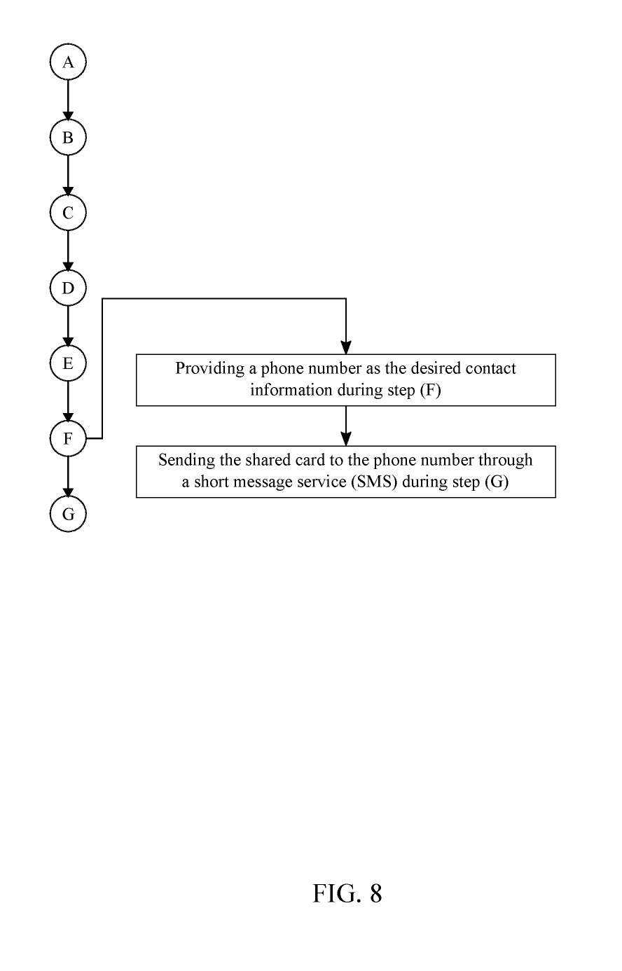

Referring to FIG. 8, in one embodiment of the present invention, a phone number is provided as the desired contact information during Step F. The user may manually enter the phone number or may access the phone number from the contact list stored in the portable computing device. The phone number acts as the desired contact information for the default text messaging application. As such, the shared card is sent to the phone number through a short message service (SMS) during Step G. Preferably, the shared card is embedded into the text message and may be viewed on the text message itself. The shared card can also be downloaded from the text message and saved on the recipient portable computing device.

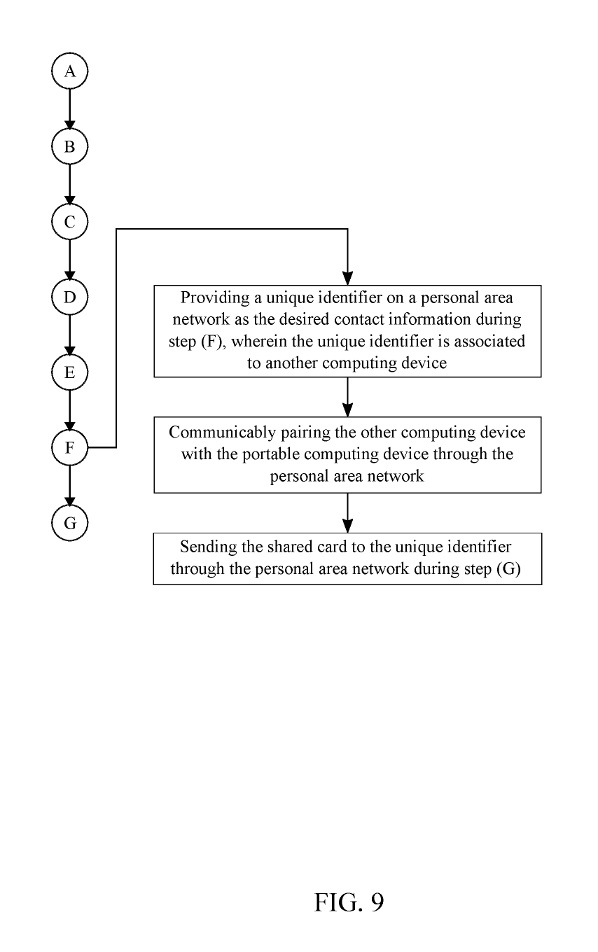

Referring to FIG. 9, in another possible embodiment of the present invention, a unique identifier on a personal area network is provided as the desired contact information during Step F, wherein the unique identifier is associated to another computing device. The other computing device refers to a smartphone or tablet owned by the business contact. Preferably, the personal area network utilizes ultra-high frequency (UHF) radio waves to establish a connection between the portable computing device and the other computing device. As such, the personal area network communicably pairs the other computing device with the portable computing device. Preferably, the unique identifier is a MAC address associated with the other computing device. In most cases, the portable computing device automatically derives the MAC address from the signals received from the other computing device. Alternately, the user can also manually input the MAC address of the other computing device. Once the portable computing device and the other computing device are communicably paired, the shared card is sent to the unique identifier through the personal area network during Step G. Preferably, the personal area network only allows the shared card to be sent to a single computing device owned by the business contact. Alternately, the personal area network can also be used to transmit the shared card amongst a plurality of computing devices and the associated business contacts.

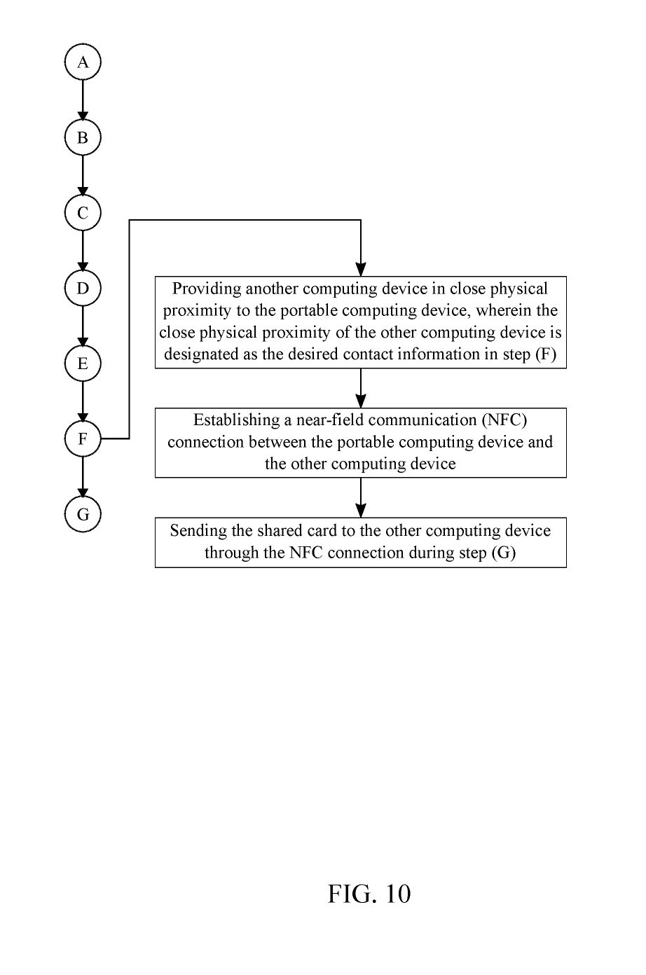

Referring to FIG. 10, in yet another embodiment, digital business cards are exchanged by touching the portable computing device to the other computing device. As such, another computing device is provided in close proximity to the portable computing device, wherein the close physical proximity of the other computing device is designated as the desired contact information in Step F. Preferably, both the portable computing device and the other computing device generate radio frequency (RF) fields that are mutually detectable. When the other computing device is in close proximity, the portable computing device registers the RF field of the other computing device as the desired contact information. Thus, a near-field communication (NFC) connection between the portable computing device and the other computing device is established. The shared card is sent to the other computing device through the NFC connection during Step G.

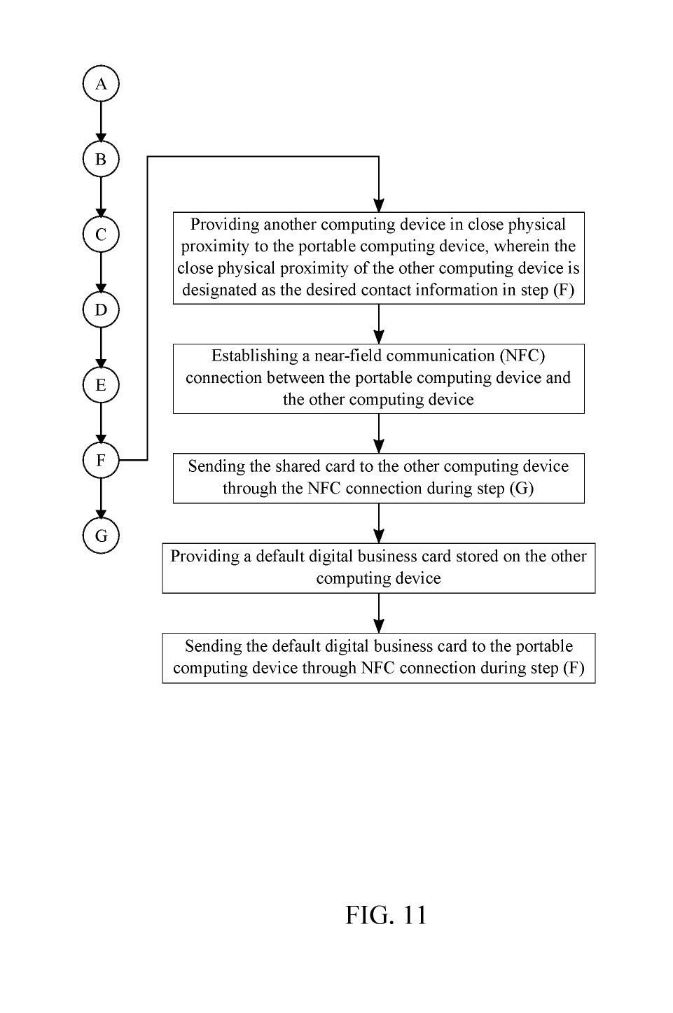

Referring to FIG. 11, similarly, the other computing device also registers the RF field of the portable computing device as the desired contact information. Thus, the NFC connection enables two-way communication between the portable computing device and the other computing device. As such, the other computing device is provided with a default digital business card stored on the other computing device. Preferably, the default business card is in the same format as the shared card of the portable computing device. For example, the other computing device may be running the same application as the portable computing device and the default business card may be shared card of the other device. The default digital business card is sent to the portable computing device through the NFC connection during Step F. The exchange of the default digital business card and the shared card may be triggered automatically when the portable computing device registers the RF field of the other device or may be controlled by the user.

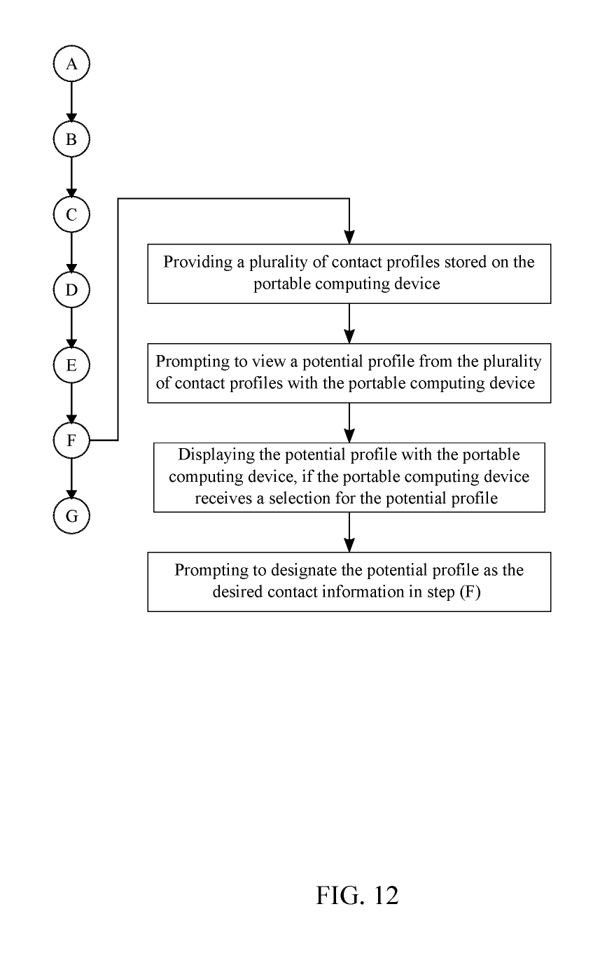

Referring to FIG. 12, when the portable computing device receives the default card from the other computing device, the application may create and store the associated business contact. As such, the portable computing device provides a plurality of contact profiles stored on the portable computing device. Each of the plurality of contact profiles contains the name, business, and contact information of the business contact. The portable computing device prompts to view a potential profile from the plurality of contact profiles. If the portable computing device receives a selection for the potential profile, the portable computing device displays the potential profile. Preferably, the user is provided with a list of the plurality of contact profiles. Selecting a potential profile displays the digital business card the contact information for associated the business contact. If the user wishes to send the digital business card to the business contact associated with the potential profile, the portable computing device prompts to designate the potential profile as the desired contact information in Step F. In this case, the business contact receiving the digital business card must also have the application of the present invention running on the receiving computing device.

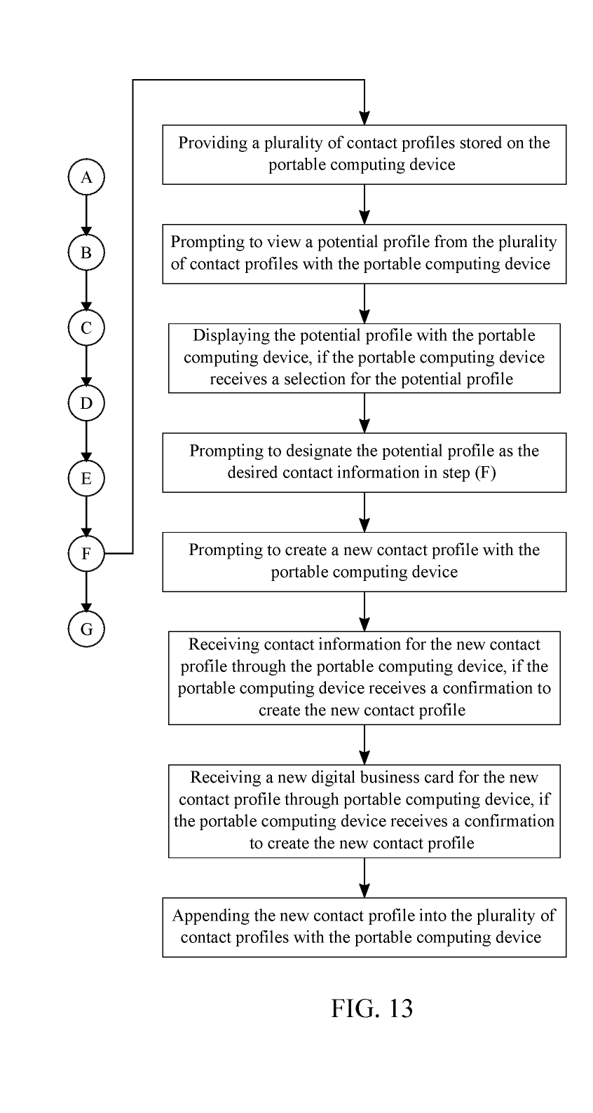

Referring to FIG. 12 and FIG. 13, preferably, when the portable computing device receives a digital business card from a business contact, the application automatically creates a contact profile. Alternately, the user may manually create a contact profile for the business contact. To achieve this, the portable computing device prompts to create a new contact profile. If the portable computing device receives a confirmation to create the new contact profile, the contact information for the new contact profile is received through the portable computing device. The user must manually enter the contact information for the business contact such as name, company, phone number, email, etc. Similarly, if the portable computing device receives a confirmation to create a new contact profile, a new digital business card is received for the new contact profile through portable computing device. Preferably, the digital business card may be uploaded into the portable computing device and added to the new contact profile. Alternately, the user can take a photo of the physical business card and add the image file to the new contact profile. Once the digital business card and the contact information is added, the new contact profile is added to the plurality of contact profiles. More specifically, new contact profile is appended into the plurality of contact profiles with the portable computing device.

Although the invention has been explained in relation to its preferred embodiment, it is to be understood that many other possible modifications and variations can be made without departing from the spirit and scope of the invention as hereinafter claimed.

What is claimed is:

1. A method of managing digital business cards, the method comprises the steps of:
(A) providing a plurality of digital business cards stored on a portable computing device;
(B) prompting to create a new card with the portable computing device;
(C) executing a card design process for the new card with the portable computing device, if the portable computing device receives a confirmation to create the new card;
(D) appending the new card into the plurality of digital business cards with the portable computing device;
(E) prompting to select at least one shared card from the plurality of digital business cards with the portable computing device;
(F) prompting to identify a desired contact information with the portable computing device; and
(G) sending the shared card from the portable computing device to the desired contact information, if the portable computing device receives a selection for the shared card, and if the portable computing device receives an identification for the desired contact information.

2. The method of managing digital business cards, the method as claimed in claim 1 comprises the steps of:
providing a plurality of graphics files stored on the portable computing device;
prompting to select a desired file from the plurality of graphics files with the portable computing device during step (C); and
designating the desired file as the new card with the portable computing device, if the portable computing device received a selection for the desired file.

3. The method of managing digital business cards, the method as claimed in claim 2 comprises the steps of:
providing a static image as the desired file;
providing a plurality of image-editing options stored on the portable computing device;
prompting to select at least one desired option from the plurality of image-editing options with the portable computing device during the step (C); and
applying the desired option on the static image with the portable computing device, if the portable computing device receives a selection for the desired option.

4. The method of managing digital business cards, the method as claimed in claim 2 comprises the steps of:
providing a dynamic image as the desired file;
providing a plurality of video-editing options stored on the portable computing device;
prompting to select at least one desired option from the plurality of video-editing options with the portable computing device during step (C); and
applying the desired option on the dynamic image with the portable computing device, if the portable computing device receives a selection for the desired option.

5. The method of managing digital business cards, the method as claimed in claim 1 comprises the steps of:
prompting to enter a background selection for the new card through the portable computing device;
prompting to enter a text selection for the new card through the portable computing device;
prompting to enter a logo selection for the new card through the portable computing device;
prompting to enter a visual-accents selection for the new card through the portable computing device; and
compiling the background selection, the text selection, the logo selection, the visual-accents selection, or a combination thereof into the new card with the portable computing device.

6. The method of managing digital business cards, the method as claimed in claim 1 comprises the steps of:
providing a plurality of third-party communication applications managed on the portable computing device;
prompting to select a desired application from the plurality of third-party communication applications with the portable computing device during step (F);
identifying the desired contact information from the desired application with portable computing device during step (F), if the portable computing device receives a selection for the desired application; and
routing the shared card through the desired application to the desired contact information during step (G).

7. The method of managing digital business cards, the method as claimed in claim 1 comprises the steps of:
providing a phone number as the desired contact information during step (F); and
sending the shared card to the phone number through a short message service (SMS) during step (G).

8. The method of managing digital business cards, the method as claimed in claim 1 comprises the steps of:
providing a unique identifier on a personal area network as the desired contact information during step (F), wherein the unique identifier is associated to another computing device;
communicably pairing the other computing device with the portable computing device through the personal area network; and
sending the shared card to the unique identifier through the personal area network during step (G).

9. The method of managing digital business cards, the method as claimed in claim 1 comprises the steps of:
providing another computing device in close physical proximity to the portable computing device, wherein the close physical proximity of the other computing device is designated as the desired contact information in step (F);
establishing a near-field communication (NFC) connection between the portable computing device and the other computing device; and
sending the shared card to the other computing device through the NFC connection during step (G).

10. The method of managing digital business cards, the method as claimed in claim 9 comprises the steps of:
providing a default digital business card stored on the other computing device; and
sending the default digital business card to the portable computing device through NFC connection during step (F).

11. The method of managing digital business cards, the method as claimed in claim 1 comprises the steps of:
providing a plurality of contact profiles stored on the portable computing device;
prompting to view a potential profile from the plurality of contact profiles with the portable computing device;
displaying the potential profile with the portable computing device, if the portable computing device receives a selection for the potential profile; and
prompting to designate the potential profile as the desired contact information in step (F).

12. The method of managing digital business cards, the method as claimed in claim 11 comprises the steps of:
prompting to create a new contact profile with the portable computing device;
receiving contact information for the new contact profile through the portable computing device, if the portable computing device receives a confirmation to create the new contact profile;
receiving a new digital business card for the new contact profile through portable computing device, if the portable computing device receives a confirmation to create the new contact profile; and
appending the new contact profile into the plurality of contact profiles with the portable computing device.

13. A method of managing digital business cards, the method comprises the steps of:
(A) providing a plurality of digital business cards stored on a portable computing device;
(B) prompting to create a new card with the portable computing device;
(C) executing a card design process for the new card with the portable computing device, if the portable computing device receives a confirmation to create the new card;
(D) prompting to enter a background selection for the new card through the portable computing device;
(E) prompting to enter a text selection for the new card through the portable computing device;
(F) prompting to enter a logo selection for the new card through the portable computing device;
(G) prompting to enter a visual-accents selection for the new card through the portable computing device;
(H) compiling the background selection, the text selection, the logo selection, the visual-accents selection, or a combination thereof into the new card with the portable computing device;
(I) appending the new card into the plurality of digital business cards with the portable computing device;
(J) prompting to select at least one shared card from the plurality of digital business cards with the portable computing device;
(K) prompting to identify a desired contact information with the portable computing device; and
(L) sending the shared card from the portable computing device to the desired contact information, if the portable computing device receives a selection for the shared card, and if the portable computing device receives an identification for the desired contact information.

14. The method of managing digital business cards, the method as claimed in claim 13 comprises the steps of:
providing a plurality of third-party communication applications managed on the portable computing device;
prompting to select a desired application from the plurality of third-party communication applications with the portable computing device during step (K);
identifying the desired contact information from the desired application with portable computing device during step (K), if the portable computing device receives a selection for the desired application; and
routing the shared card through the desired application to the desired contact information during step (L).

15. The method of managing digital business cards, the method as claimed in claim 13 comprises the steps of:
providing a plurality of contact profiles stored on the portable computing device;
prompting to view a potential profile from the plurality of contact profiles with the portable computing device;
displaying the potential profile with the portable computing device, if the portable computing device receives a selection for the potential profile;
prompting to designate the potential profile as the desired contact information in step (K);
prompting to create a new contact profile with the portable computing device;
receiving contact information for the new contact profile through the portable computing device, if the portable computing device receives a confirmation to create the new contact profile;
receiving a new digital business card for the new contact profile through portable computing device, if the portable computing device receives a confirmation to create the new contact profile; and
appending the new contact profile into the plurality of contact profiles with the portable computing device.

16. A method of managing digital business cards, the method comprises the steps of:
(A) providing a plurality of digital business cards stored on a portable computing device;
(B) prompting to create a new card with the portable computing device;
(C) executing a card design process for the new card with the portable computing device, if the portable computing device receives a confirmation to create the new card;
(D) providing a plurality of graphics files stored on the portable computing device;
(E) prompting to select a desired file from the plurality of graphics files with the portable computing device during step (C);
(F) designating the desired file as the new card with the portable computing device, if the portable computing device received a selection for the desired file;
(G) appending the new card into the plurality of digital business cards with the portable computing device;
(H) prompting to select at least one shared card from the plurality of digital business cards with the portable computing device;
(I) prompting to identify a desired contact information with the portable computing device; and
(J) sending the shared card from the portable computing device to the desired contact information, if the portable computing device receives a selection for the shared card, and if the portable computing device receives an identification for the desired contact information.

17. The method of managing digital business cards, the method as claimed in claim 16 comprises the steps of:
providing a plurality of third-party communication applications managed on the portable computing device;
prompting to select a desired application from the plurality of third-party communication applications with the portable computing device during step (I);
identifying the desired contact information from the desired application with portable computing device during step (I), if the portable computing device receives a selection for the desired application; and
routing the shared card through the desired application to the desired contact information during step (J).

18. The method of managing digital business cards, the method as claimed in claim 16 comprises the steps of:
providing a phone number as the desired contact information during step (I); and
sending the shared card to the phone number through a short message service (SMS) during step (J).

19. The method of managing digital business cards, the method as claimed in claim 16 comprises the steps of:
providing a unique identifier on a personal area network as the desired contact information during step (I), wherein the unique identifier is associated to another computing device;
communicably pairing the other computing device with the portable computing device through the personal area network; and
sending the shared card to the unique identifier through the personal area network during step (J).

20. The method of managing digital business cards, the method as claimed in claim 16 comprises the steps of:
providing another computing device in close physical proximity to the portable computing device, wherein the close physical proximity of the other computing device is designated as the desired contact information in step (I);
establishing a near-field communication (NFC) connection between the portable computing device and the other computing device; and
sending the shared card to the other computing device through the NFC connection during step (J).
